(19) United States
(12) Patent Application Publication
(10) Pub. No.: US 2004/0066940 A1
(43) Pub. Date: Apr. 8, 2004

(54) Method and system for inhibiting noise produced by one or more sources of undesired sound from pickup by a speech recognition unit

(75) Inventor: Nehemia Amir, Rishon Lezion (IL)

Correspondence Address: OLIFF & BERRIDGE, PLC, P.O. BOX 19928, ALEXANDRIA, VA, 22320, US

(73) Assignee: SILENTIUM LTD., Rehovot (IL)

(21) Appl. No.: 10/262,838

(22) Filed: Oct. 3, 2002

(51) Int. Cl. H04B 15/00

(52) U.S. Cl. 381/94.2

(57) ABSTRACT

A method and system for inhibiting noise produced by one or more sources of undesired sound from pickup by a speech recognition unit, where a respective transducer is located proximate each source of undesired sound for converting each source of undesired sound to a corresponding electrical signal, and a noise reduction system is coupled to each of the transducers for converting each electrical signal to an equivalent anti-phase electrical signal of equal amplitude. An output of the noise reduction or a signal corresponding thereto is fed to the speech recognition unit so each of the anti-phase electrical signals cancels or reduces a corresponding electrical signal produced by the speech recognition unit upon picking up the undesired sound from the respective source.

### FIELD OF THE INVENTION

This invention relates to noise reduction systems.

### BACKGROUND OF THE INVENTION

It is known to use noise reduction systems in vehicles in order to reduce acoustic interference when using mobile telephones. JP 8248963 to Mazda Motor Corporation of Japan published Sep. 27, 1996 and entitled “Noise Reduction Device For Vehicle” describes a commonly used approach where the noise reduction device is provided with a microphone and a speaker, and is constituted so as to reduce a noise by generating a sound of a phase opposite to the noise in the vehicle collected by the microphone from the speaker. Likewise, JP 10254457 to Isuzu Motors Ltd. of Japan published Sep. 25, 1998 and entitled “Reducing Method of Noise Within Vehicle Compartment and Device Therefor” is directed to noise reduction over a wide frequency band by forming a canceling sound producing signal based on measured actual noise, producing a canceling sound from a speaker by using the canceling sound producing signal and interfering it with a noise.

To this end, a microphone for detecting noise and a speaker for emitting a canceling sound producing means are arranged within a vehicle compartment. The microphone measures sound generated within the vehicle compartment, the phase and acoustic pressure are detected in two and more resonant frequency bands of cavity resonance and a controller produces a canceling sound producing signal. The speaker emits a canceling sound for interfering with the noise thereby reducing the noise.

U.S. Pat. No. 5,485,523 (Tamamura et al.) published Jan. 16, 1996 and entitled “Active noise reduction system for automobile compartment” discloses an automobile compartment noise reduction system, where an ignition pulse signal is processed to obtain a vibration noise source signal with a frequency spectrum composed of 0.5 n (integers) order components of the engine r.p.m. as the primary source signal. The signal is applied to an adaptive filter and an LMS calculating circuit via a speaker-microphone transmission characteristic correcting circuit. The primary source signal is synthesized by the filter into a cancel signal and then outputted through a speaker as canceling sound. The canceling sound is received by at least one error microphone at a noise receiving point as an error signal. The error signal is applied to the LMS calculating circuit. The LMS circuit updates the filter coefficients of the adaptive filter on the basis of the primary source signal and the error signal so that the error signal can be minimized.

Owing to the high background noise inside the vehicle compartment, it is very difficult for speech recognition systems to be effective. Noise sources include wind, road, air conditioning system, sound system.

Currently available systems for reducing the background noise in speech recognition systems or in communication devices of the type described above use a directional microphone or several microphone elements, in order to increase the microphone sensitivity in the direction of the speaker. The limitation of such systems is that they cannot hear the passenger near the driver, and cannot reduce the noise coming from the car audio system.

Other systems increase the speech recognition, using algorithms that are based on the speech statistics parameters. The limitation of this method is that its effectiveness is dramatically reduced in the presence of background noise.

### SUMMARY OF THE INVENTION

It is an object of the invention to provide an alternative method and system for inhibiting the effect of unwanted noise from being picked up by a speech operated system.

The invention finds particular application when the speech operated system is an automatic system that is used to understand and execute voice instructions, for example, a vocally operated mobile telephone that is adapted to obey vocal instructions. Within the context of the following description and claims, such a system will be referred to as a speech recognition unit. However, the system also improves telephone communications in noisy environments such as vehicles, even though humans do understand even in a noisy environment. Machines do not have the intelligence to discriminate genuine acoustic signals from background noise, so while the present invention is beneficial for telephone pick up, its principal utility is for speech recognition systems.

To this end there is provided in accordance with a first aspect of the invention a method for inhibiting noise produced by one or more sources of undesired sound from pickup by a speech recognition unit, the method comprising:

obtaining separate electrical source signals each relating to a respective source of undesired sound,

producing a plurality of anti-phase electrical signals each corresponding to a respective one of the electrical source signals and of equal amplitude thereto, and

injecting into the speech recognition unit a signal corresponding to each of the anti-phase electrical signals so that it cancels or reduces a corresponding electrical signal produced by the speech recognition unit upon picking up the undesired sound from the respective source.

A system in accordance with invention for inhibiting noise produced by one or more sources of undesired sound from pickup by a speech recognition unit, comprises:

an electrical circuit responsive to corresponding electrical source signals each relating to a respective source of undesired sound for producing in respect of each of said electrical source signals an equivalent anti-phase electrical signal of equal amplitude fed to an output of the circuit;

the output of the circuit or a signal corresponding thereto being fed to the telephone mouthpiece so that each of the anti-phase electrical signals cancels or reduces a corresponding electrical signal produced by the speech recognition unit upon picking up the undesired sound from the respective source.

Preferably, the system is disposed within a vehicle for reducing extraneous background noise from being picked up by a mobile telephone pickup. Such a system is a source-orientated system that electrically or acoustically reduces the noise originating from dedicated noise sources within the vehicle, at the microphone point of speech recognition systems or communication devices such as cellular phones. Thus, according to one embodiment, an electrical output of the circuit is directly summed with the microphone electrical signal within the telephone pickup so to cancel or reduce a corresponding electrical signal produced thereby upon picking up the undesired sound from the respective source. Alternatively, the anti-phase electrical output may be converted back to an acoustic signal that is fed to the telephone pickup via a loudspeaker placed proximate thereto.

In either case, a principal benefit of such a system is that the signal to noise ratio is increased at the pickup. This improves the performance of speech recognition systems and other devices that utilize microphones within a vehicle, while allowing the use of an omni-directional microphone within the telephone pickup. This is preferable to use of a uni-directional microphone, which is not only more expensive but less suitable than an omni-directional microphone in a vehicle environment where a motorist must be free to move his head relative to the telephone pickup.

The system may operate by its own or as additional improvements to other technologies for signal to noise improvement.

The system handles dedicated noise sources within a vehicle: air conditioning system, audio system, motor noise, vibrations at the microphone point etc. The advantage of the system is that there is a large reduction of the disturbing sources, while the microphone remains omni-directional.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic representation of a system according to the invention;

FIG. 2 is a schematic representation of a first implementation of a system according to the invention for reducing multiple noise sources;

FIG. 3 is a schematic representation of an alternative implementation of a system according to the invention for reducing multiple noise sources;

FIG. 4 is a schematic representation of another implementation of a system according to the invention for reducing multiple noise sources.

### DETAILED DESCRIPTION OF THE INVENTION

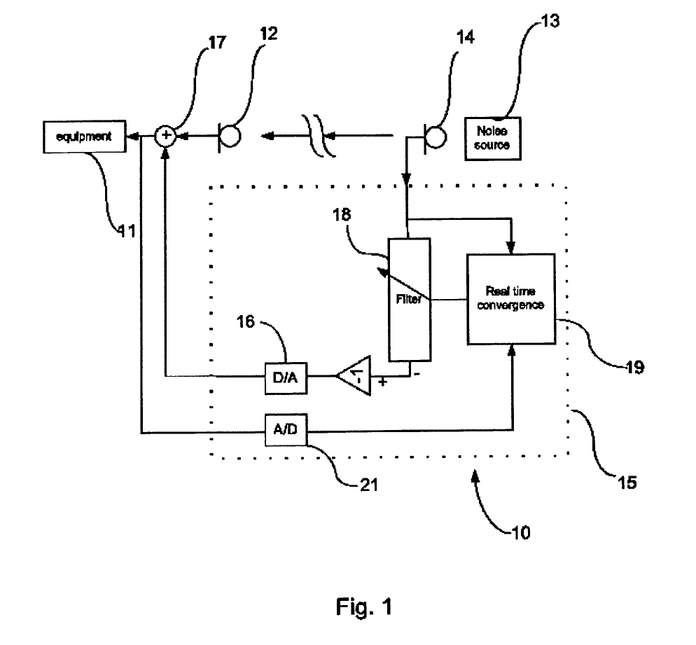

FIG. 1 is a schematic representation of a system 10 according to the invention comprising a speech recognition unit 11 having a microphone 12. A noise source 13 is located within sufficient proximity to the speech recognition unit 11 that sound produced by the noise source 13 is capable of being picked up by the microphone 12 and interfering with its operation. A sensing microphone 14 is set up proximate the noise source 13 and is connected to a noise reduction system shown generally as 15 that includes an electronic circuit that is responsive to a noise signal fed thereto for estimating in real time a transfer function, which creates an active electrical signal representing an inverse of the noise signal. The output of the noise reduction system is multiplied by −1 (i.e. inverted) and converted to an equivalent analog signal by a D/A converter 16, whose output is added directly to the microphone output 12 by an adder 17.

The noise reduction system 15 includes a digital filter such as finite impulse response (FIR) filter 18 having an input that is coupled to the output of the sensing microphone 14 and which is used to estimate the transfer function. The FIR filter 18 is controlled by a real time convergence system 19 whose input is likewise coupled to the output of the sensing microphone 14. The output of the FIR filter 18 is inverted by an inverter 20. The real time convergence system 19 receives a feedback signal from the analog input signal fed to the speech recognition unit and which is digitized by an A/D converter 21. The real time convergence system 19 converges to the transfer function and may be based on any of several well-known convergence algorithms such as LMS (least mean square), RLS and so on.

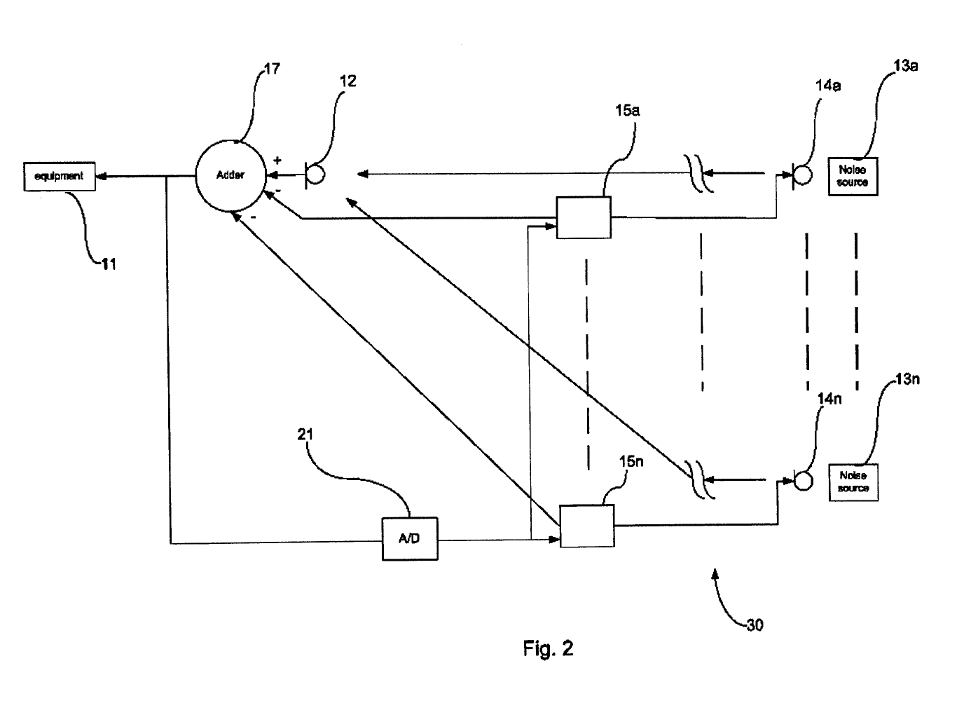

FIG. 2 is a schematic representation of a first implementation of a system 30 according to the invention for reducing multiple noise sources. Identical reference numerals are used to refer to components that are common to the system 30 and the system 10 described above with reference to FIG. 1 of the drawings. Thus, the system 30 includes a speech recognition unit 11 having a microphone 12, which is to be isolated from acoustic noise generated by multiple noise sources designated as 13a . . . 13n. A respective sensing microphone 14a . . . 14n is placed near each of the n noise sources, each microphone being connected to a respective noise reduction system 15a . . . 15n whose respective analog outputs are summed together with the analog signal fed to the equipment microphone 12 by an adder 17. An analog output of the adder 17 is converted to an equivalent digital signal by an A/D converter 21, and fed back to each of the noise reduction systems 15a . . . 15n.

The noise reduction systems 15a . . . 15n may be identical to that described above with reference to FIG. 1 or it may be a multi-channel unit having n-inputs for receiving the n noise signals, an input for receiving the feedback signal and an output for producing a composite output signal. In the case that discrete noise reduction systems are used, as shown in FIG. 2, it is also possible to use a separate A/D converter for each noise reduction system.

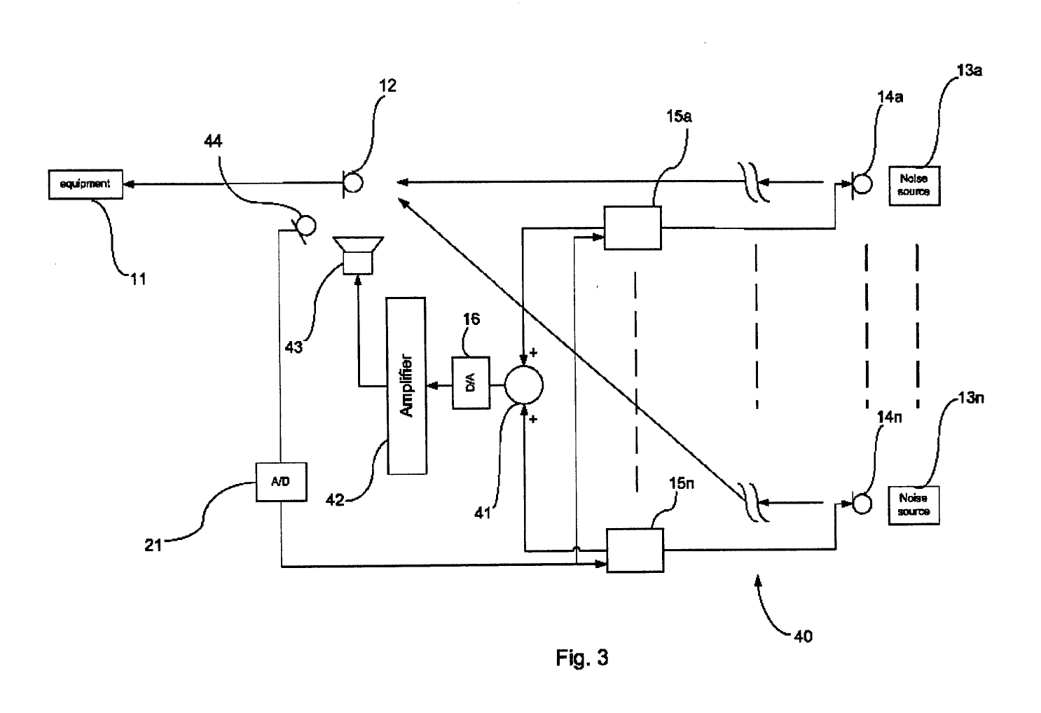

FIG. 3 is a schematic representation of a second implementation of a system 40 according to the invention for reducing multiple noise sources, wherein noise reaching the microphone 12 of the speech recognition unit 11 is reduced without actually connecting to the microphone 12. Again, identical reference numerals are used to refer to components that are common to the systems 10 and 30 described above with reference to FIGS. 1 and 2 of the drawings.

All of the digital outputs of the noise reduction systems 15a . . . 15n are summed together by a summation unit 41 producing a composite summed output signal that is converted to an equivalent analog signal by a D/A converter 16. It is also possible to use separate D/A converters for each of the noise reduction systems 15a . . . 15n as explained above with reference to FIG. 2. The output of the D/A converter 16 is amplified by an amplifier 42 and vocalized by a loudspeaker 43 located proximate the microphone 12 for generating counter noise that cancels the acoustic noise picked up by the microphone 12. A feedback microphone 44 is likewise located near the loudspeaker 43 for generating the analog feedback signal, which is digitized by the A/D converter 21 and fed to the noise reduction systems 15a . . . 15n. The sensing microphones 14a . . . 14n are preferably uni-directional microphones that are located proximate the microphone 12 of the speech recognition unit 11. By such means, each sensing microphone 14a . . . 14n senses the actual noise that reaches the speech recognition unit 11 so that the counter-noise output by the loudspeaker 43 exactly nullifies the effect of the respective noise component reaching the speech recognition unit 11.

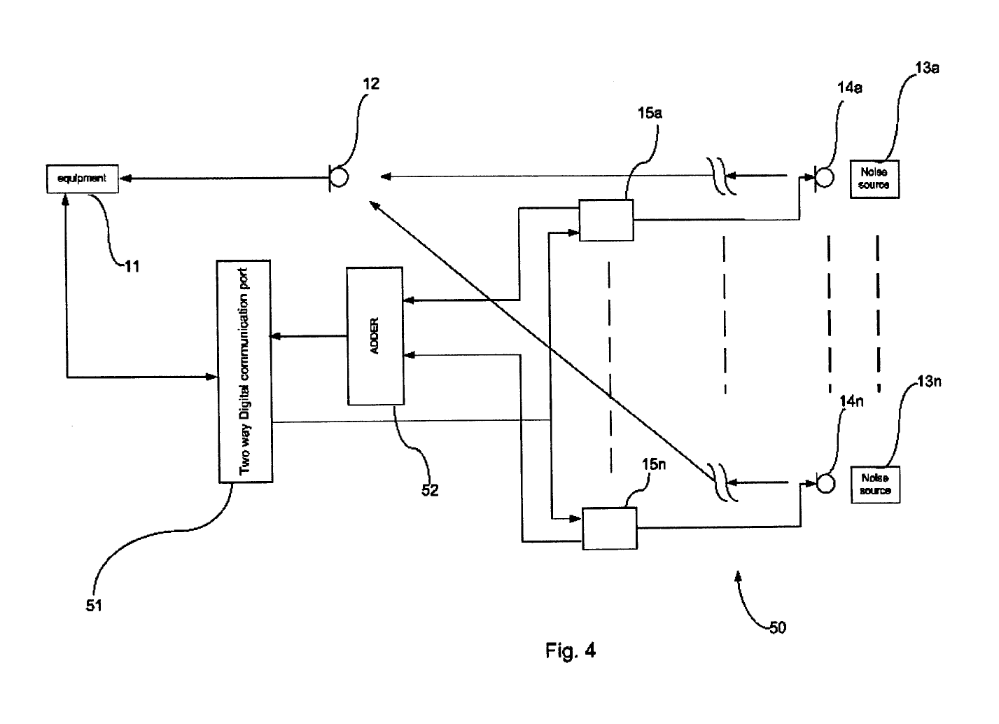

FIG. 4 is a schematic representation of a third implementation of a system 50 according to the invention for reducing multiple noise sources, wherein noise reaching the microphone 12 of the speech recognition unit 11 is reduced without actually connecting to the microphone 12. However, the system 50 is adapted for use with a digital speech recognition unit where the input signal is digital rather than analog. Again, identical reference numerals are used to refer to components that are common to the systems 10, 30 and 40 described above with reference to FIGS. 1, 2 and 3 of the drawings.

All of the digital outputs of the noise reduction systems 15a . . . 15n are fed to a two-way digital communication port 51. In a single channel system, the digital communication port 51 conveys the digital inverse signal directly to the speech recognition unit 11. In a multi-channel system, the digital communication port 51 is coupled to the output of an adder 52 that serves as a summing unit for summing the digital inverse signals digitally. In either case, since the speech recognition unit 11 is digital, there is no need for A/D and D/A conversion. The digital output of the digital communication port 51 is fed directly as an electrical digital signal to the speech recognition unit 11. The digital communication port 51 outputs a composite error digital signal that is fed back to all of the noise reduction systems 15a . . . 15n in a similar manner to what is done in the analog system 40 shown in FIG. 3. Clearly, in a single channel system only a single feedback signal is produced and fed to the single noise reduction system.

In any of the systems 10, 30, 40 or 50 one or more sensing microphone 14 may be replaced by a transducer for producing an analog signal representative of a physical property that manifests itself as acoustic noise. For example, one or more sensing microphones 14 might be replaced by an accelerometer for sensing acoustic noise derived from vibrations that must be reduced at the microphone 12 of the speech recognition unit 11. Alternatively, one or more of the sensing microphones 14 might be replaced by direct connection to a loudspeaker in a sound system. It will be appreciated that the noise reduction system 15 may also include different kinds of input transducers at the same time. It is also possible to dispense with any of the microphones or other transducers in any of the systems if direct access is possible to an electrical source signal relating to a respective source of undesired sound.

1. A method for inhibiting noise produced by one or more sources of undesired sound from pickup by a speech recognition unit, the method comprising:
obtaining separate electrical source signals each relating to a respective source of undesired sound,
producing a plurality of anti-phase electrical signals each corresponding to a respective one of the electrical source signals and of equal amplitude thereto, and
injecting into the speech recognition unit a signal corresponding to each of the anti-phase electrical signals so that it cancels or reduces a corresponding electrical signal produced by the speech recognition unit upon picking up the undesired sound from the respective source.

2. The method according to claim 1, including using a respective transducer located proximate each source of undesired sound to convert each source of undesired sound to the corresponding electrical signal.

3. The method according to claim 1, wherein the signal injected into the speech recognition unit is an analog electrical signal.

4. The method according to claim 1, wherein the signal injected into the speech recognition unit is an acoustic signal.

5. The method according to claim 1, wherein the signal injected into the speech recognition unit is a digital signal.

6. A system for inhibiting noise produced by one or more sources of undesired sound from pickup by a speech recognition unit, the system comprising:
an electrical circuit responsive to corresponding electrical source signals each relating to a respective source of undesired sound for producing in respect of each of said electrical source signals an equivalent anti-phase electrical signal of equal amplitude fed to an output of the circuit;
the output of the circuit or a signal corresponding thereto being fed to the speech recognition unit so that each of the anti-phase electrical signals cancels or reduces a corresponding electrical signal produced by the speech recognition unit upon picking up the undesired sound from the respective source.

7. The system according to claim 6, including a respective transducer located proximate each source of undesired sound for converting each source of undesired sound to the corresponding electrical source signal.

8. The system according to claim 6, wherein the signal injected into the speech recognition unit is an analog electrical signal.

9. The system according to claim 6, wherein the signal injected into the speech recognition unit is an acoustic signal.

10. The system according to claim 6, wherein the signal injected into the speech recognition unit is a digital signal.

11. The system according to claim 6, wherein at least one transducer is a microphone.

12. The system according to claim 6, wherein at least one transducer produces an analog signal representative of a physical property that manifests itself as acoustic noise.

13. The system according to claim 6, wherein the electrical circuit comprises:
a digital filter having an input that is coupled to the output of a respective one of the transducers and which is controlled by a real time convergence system having an input coupled to the output of said transducer,
an inverter coupled to an output of the digital filter for inverting a filtered output signal produced by the digital filter, and
an A/D converter for receiving at an input thereof an analog signal fed to the speech recognition unit and for producing at an output thereof an equivalent digital signal;
the real time convergence system being coupled to the output of the A/D converter for receiving a feedback signal therefrom.

14. The system according to claim 6, wherein the electrical circuit is a multi-channel unit having n-inputs for receiving n noise signals, a single input for receiving the feedback signal in respect of all said channels and a single output for producing a composite output signal in respect of all of said channels.

15. The system according to claim 6, wherein the electrical circuit is a plurality of n noise reduction systems each having an input for a respective one of the noise signals, an input for receiving the feedback signal and an output for producing a respective output signal.

16. The system according to claim 15, further including:
a summation unit for summing together the respective outputs of each of the noise reduction systems and producing a composite summed output signal,
a D/A converter coupled to an output of the summation unit for converting the composite summed output signal to an equivalent analog signal,
an amplifier coupled to an output of the D/A converter,
a loudspeaker coupled to the amplifier and located proximate the microphone of the speech recognition unit for generating counter noise that cancels the acoustic noise picked up by said microphone, and
a feedback microphone located near the loudspeaker for generating an analog feedback signal, which is digitized by the A/D converter and fed back to the noise reduction systems.

17. The system according to claim 15, further including:
a respective D/A converter coupled to each of the noise reduction systems for producing a corresponding analog signal,
a summation unit for summing together the respective analog signals and producing a composite summed analog output signal,
an amplifier coupled to an output of the summation unit,
a loudspeaker coupled to the amplifier and located proximate the microphone of the speech recognition unit for generating counter noise that cancels the acoustic noise picked up by said microphone, and
a feedback microphone located near the loudspeaker for generating an analog feedback signal, which is digitized by the A/D converter and fed back to the noise reduction systems.

18. The system according to claim 6, wherein the speech recognition unit is a digital device and the electrical circuit comprises:
a digital filter having an input that is coupled to the output of a respective one of the transducers and which is controlled by a real time convergence system having an input coupled to the output of said transducer,
an inverter coupled to an output of the digital filter for inverting a filtered output signal produced by the digital filter thereby producing a digital inverse signal, and
a two-way digital communication port for conveying the digital inverse signal to the speech recognition unit and for conveying a feedback signal to the real time convergence system.

19. The system according to claim 18, wherein the electrical circuit is a multi-channel unit having n-inputs for receiving n noise signals, a single input for receiving the feedback signal in respect of all said channels and a single output for producing a composite digital output signal in respect of all of said channels.

20. The system according to claim 19, wherein the two-way digital communication port is coupled to a summation unit for summing together the respective digital inverse signals and producing a composite summed digital output signal.

21. The system according to claim 18, wherein the electrical circuit is a plurality of n noise reduction systems each having an input for a respective one of the noise signals, an input for receiving the feedback signal and an output for producing a respective output signal.

22. The system according to claim 21, wherein the two-way digital communication port is coupled to a summation unit for summing together the respective digital inverse signals and producing a composite summed digital output signal.
